(19) United States
(12) Patent Application Publication
(10) Pub. No.: US 2005/0253840 A1
(43) Pub. Date: Nov. 17, 2005

(54) Method and system for interactive three-dimensional item display

(76) Inventor: Ryan Young Wook Kwon, Fullerton, CA (US)

Correspondence Address: Ryan Young Wook Kwon, 1216 Begovich St., Fullerton, CA, 92833, US

(21) Appl. No.: 11/111,030

(22) Filed: Apr. 21, 2005

Related U.S. Application Data
(60) Provisional application No. 60/569,962, filed on May 11, 2004.

(51) Int. Cl. G06T 15/00

(52) U.S. Cl. 345/419

(57) ABSTRACT

A system and method for interactive three-dimensional (3D) object simulation is provided that includes a simulated interactive 3D environment that runs locally on the user's computer, and provides automatic compatibility handling to enable vendors and consumers to place, modify, manipulate, integrate, and freely move virtual products in the 3D environment. Other embodiments may additionally include any combination of means for a vendor to create a 3D virtual store in the interactive 3D environment, and means for making the virtual object is dimensionally proportional in measurement to the dimensional measurements of the corresponding physical object.

### CROSS-REFERENCE TO RELATED APPLICATIONS

The present Utility patent application claims priority benefit of the U.S. provisional application for patent 60/569,962 filed on May 11, 2004 under 35 U.S.C. 119(e).

### FIELD OF THE INVENTION

The present invention relates generally to electronic commerce (e-commerce) systems. More particularly, the invention relates to e-commerce systems and methods that enable simulation of electronically represented products to be interacted with in three dimensions (3-D) and be displayed on a user's display device.

### BACKGROUND OF THE INVENTION

The internet has become a large marketplace where many commercial transactions take place. It is growing and most predict that it will continue to grow. However, the ways in which products are displayed on the internet are limited. Many displayed products are static images embedded in HTML, where the consumers have limited view or interaction with products being displayed on the web. Companies like Viewpoint, and Cult 3D have tried to solve this problem by using their 3D software platforms to display products in 3D. These software platforms allow products to be rotated, zoomed and manipulated to get a better look at the products and how they look three dimensionally. Additionally, products are animated so various parts of products can move, and these companies continue to add new features to enhance accurate pictures of products.

However, these 3D images are limited to viewing and manipulating one image and these images cannot interact with other images. For example, if an automobile were displayed in 3D, it could not interact with other products, compared in size to other products etc. In addition, all the items are restricted to a vendor's domain, so the consumer could not compare the products with other vendors on the web or make the item interact with other products from different vendors. Therefore, there is a need for a system in which users can make purchase decisions based upon as much information as possible, while having the option to select from a variety of vendors.

One area of exemplary need is in the clothing industry. To better suit the consumer's choice, various methods have tried to obtain vendor's computer clothing image, and integrate the possible clothing images with the consumer's image so the consumer would get a more accurate simulation for purchase. This however, is limited to a certain system, to the clothing industry, and does not address various other kinds of products.

Some attempts at 3-D product e-commerce have been directed to product display systems that allows users to synthesize their image with products which are registered in their system database, and, thereby, allow for more interactivity with products in the internet. In such approaches, clients typically need to be members to enter their system, and within their internal system, they have image preparation/synthesis means in which the client is able to synthesize the various products of their database with his or her image. Other similar approaches are directed towards a virtual shopping mall system, which allows for a suitability test in which the client image is combined with a product in the shopping mall. Unfortunately, again clients need to be members and registered into the shopping mall. Moreover, such approaches often suffer from the fact that their display systems are restricted to their system parameters, which limits the capacity of the shopping experience to their mall system. In addition, customers are not able make purchase decisions “offline” without entering the system. Also, the processing, searching and image preparing is done centrally in their system which may put a severe burden on the main server.

In view of the foregoing, there is a need for a software platform that enables a user to locally process product/environmental data received from a network server to make a virtual product experience which is 3-D and interactive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates by way of example the relationships of the consumer and the vendor, in accordance with one embodiment of the present invention;

FIG. 2 illustrates an exemplary a method for properly handling potentially incompatible 3^{rd} party objects that enter SP 102, in accordance with an embodiment of the present invention;

FIG. 3 illustrates an exemplary method of how obtained products from various sources can be carried out, in accordance with an embodiment of the present invention;

FIG. 4 illustrates an exemplary block diagram showing the flexible architecture of the Software Platform, in accordance with an embodiment of the present invention;

FIG. 5 illustrates an example of the integration feature, in accordance with an embodiment of the present invention;

FIG. 6 illustrates an example of the placement feature, in accordance with an embodiment of the present invention;

FIG. 7 illustrates an example of an embedded SP interface within another browser, in accordance with an embodiment of the present invention;

FIG. 8 illustrates an exemplary centralized a virtual environment server architecture, in accordance with an embodiment of the present invention;

FIG. 9 illustrates an exemplary top-level architecture of how users and vendors connect to a virtual store, in accordance with an embodiment of the present invention; and

FIG. 10 illustrates a typical computer system that, when appropriately configured or designed, can serve as a computer system in which the invention may be embodied

Unless otherwise indicated illustrations in the figures are not necessarily drawn to scale.

### SUMMARY OF THE INVENTION

To achieve the forgoing and other objects and in accordance with the purpose of the invention, a variety interactive three-dimensional item simulation techniques are described.

In one embodiment of the present invention a system for interactive three-dimensional (3D) object simulation is provided that includes means (e.g., computer code) for simulating an interactive 3D environment, means for receiving an object (e.g., an item or product) that has a particular format, means for checking if the object is in a compatible format, means for converting the format of the object to a compatible format, means for determining if modifications are required to the object to make the object functionally compatible with the 3D environment simulating means, and means for modifying the object to make the object functionally compatible with the 3D environment simulating means, whereby the 3D environment simulating means is operable to receive and properly integrate the object into the simulated interactive 3D environment, thereby creating a simulated version of the object, or virtual object, in the simulated interactive 3D environment. Means for displaying the interactive 3D environment is also provided.

Other embodiments may additionally include any combination of means for manipulating the virtual object at least partially similar to the real world manipulation and/or placement of a physical version of the object, means for at least partially simulating real-world physics in the interactions and/or integration between virtual objects and between the virtual object and the interactive 3D environment, means for enabling a consumer to integrate virtual objects obtained from a plurality of vendors, means for enabling a vendor to place an object into the interactive 3D environment, means for a vendor to create a 3D virtual store in the interactive 3D environment, and/or means for making the virtual object is dimensionally proportional in measurement to the dimensional measurements of the corresponding physical object.

A method and/or computer code for achieving the foregoing embodiment is also provided.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments.

In 3D graphics applications such as Cinema 4D, Bryce, True Space, etc., three dimensional objects can be created using these programs. The end result is phenomenal and many would not be able to tell that the image was created using graphics software. It offers a 3D user interface in which objects can be viewed in all directions, viewpoints and/or other perspectives. In addition, objects in these programs can be rendered, animated and one is able to add motion to various parts of objects. Other users using the same software applications are able to import and/or export these objects into their computers and share the various objects and within their software application or platform. The objects can then be integrated with other objects, differentiated, viewed in numerous panes, animated, moved, placed in another location etc. The user of this computer application has the freedom to manipulate multiple objects any way they like. In addition, all the objects can be consolidated and be animated using rendering techniques in their software program. Although the enabling technologies are commonly available, the need exists for a commercial system in which simulated products in a virtual environment (“virtual products”) are able to interact as they do in these 3D computer graphics programs which would allow for further simulation of items.

In many cases, as will be exemplified below, it is desirable to be able to interact with the virtual products while “offline” (i.e., while not connected to a network server); however, for virtual products to be interactive “offline” it may be necessary for the virtual products to be transferred directly to the consumer and be stored in the consumer's database. Alternatively if items are not stored in a database, any data may be transferred, processed and displayed when the data is received from another party. In addition, it would require a software platform which will receive the data, process the information and render the final display all within the user computer/terminal. Presently, a very similar technical process is carried out by gaming engines.

If a software platform is used to address this issue, user's computer (or any other device) generates, processes, and displays the images on his or her computer or terminal. There is no need for a centralized mall system which does all that for a user. So it is the intent of the present invention to allow a common software platform, in which data formulas of virtual products from various vendors can be transferred to the consumer where this data will be processed, rendered, displayed and enable interactivity at the consumer/client level.

One aspect of the present invention is to allow both the vendors and the consumers to communicate on the web (or any other communication means) through a common software platform which allows virtual products to be displayed and be interactive. Interactivity allows for different virtual products to be integrated, compared, located in various settings and various other features which will be discussed below. Using the software platform/system platform (SP), consumers can make better judgments in their purchase decision by displaying the interactive features of the SP.

Products displayed on the web are limited in many cases to a single view allowing no or minimal interactivity at the consumer/user level.

One aspect of this present invention is that it allows consumers to make purchase decisions “offline”. In addition, the invention does not require a centralized system in which the consumers need to register or limit shopping to a centralized location. For example, in a currently known system, a client needs to be registered and entered into their mall system. Upon entering, the image preparing, processing and synthesizing is done at the central location. Therefore the user would not be able to implement the features “outside” of their system.

Anyone familiar in the art will realize that there are many methodologies known in the art today to create 3D images. 3D virtual products can be produced in various ways such as 3D scanners, stereoscopic methods using cameras, created using 3D graphics programs, 3D image capture using turntables etc. In addition, through various rendering and image processing techniques, 3D images can be animated and allow further interaction with other objects. As there is no 3D graphics display standard on the web, a consortium is trying to standardize the 3D graphics across applications and platforms. Therefore, the standardizing consortium efforts to eventually implement standardized 3D images to be viewed on the web so that all medical scans, commercial 3D products, CAD, etc. will all be standardized and will be able to be viewed using this set standard. However, the eventual standardization of 3D graphics display does not mean that the standardized 3D images will be interactive with other 3D images.

In an embodiment of the present invention, the users will be running a gaming program in their computer which interprets the data transmitted (e.g., a 3D virtual product and/or a 3D virtual environment) from a server or another user, then processes and renders the target virtual objects on the user's computer based upon the data given. In addition, as is well known, there are many computer games that allow users to create their own characters, weapons, object etc. Typically, all this new information within the gaming programs are transferred and processed on another user's computer. In this way, an aspect of the present invention combines the technologies of 3D graphics software and gaming software in order to display the items described in the invention.

Although various methods exist for 3D display of products, displays are restricted to a vendor's website and the interactive capabilities are limited or nonexistent. For example, a consumer cannot make products from two different vendors interact with each other and display them on the same screen. One aspect of the present invention provides a software platform system in which various vendors will share a common product data in which the consumer can process and display the data from their computer/terminal and implement the features of the SP.

In one embodiment, the SP allows the consumers to further simulate products to get an accurate, desired view of products enabling consumers to make more informed purchase decisions. For example, consumers may want to integrate two virtual products together to get a better idea of what the virtual products look like together when the two virtual products are combined together (i.e. custom tail lights installed on an automobile).

Any consumer who shops on the internet through a communications network would gain additional interactive capabilities from the present invention. The present invention will allow the consumers to simulate various aspects of “real shopping” from their computer or terminal with products from various vendors which support the SP. This will increase consumer satisfaction, increase efficiency for the vendors and will make internet shopping a preferred method of making purchases. Vendors could gain as overhead costs go down, and vendors can increase sales due to the increased capability of the consumer to make an informed purchase on the internet.

One aspect of the present invention is to develop a software platform which allows objects to be manipulated and integrated through the software to interact and also be portrayed substantially like objects in the real world. For example, objects can interact by integrating together, placed in a location together, viewed in 3 dimensions, and other interactive features that one can do with products in the real world.

One embodiment of the present invention is to allow the SP to process, render, and display the object (virtual product) data at the user level. Using the SP and thereby allowing image processing at the user level, no centralized system or server is needed. Furthermore, if a centralized server is required to run more efficiency, it reduces the burden of the server due to the fact that all the data processing is done at the consumer level. The server may store data for vendors or consumers, or it may act as a portal or a gateway in which data is transmitted properly, but the server is not a data processing center for virtual products/items to be displayed. This will allow vendors to be independent of any shopping systems or malls allowing the user to apply the interactive features with any vendor's products that supports the SP.

An enabling technology for some features of the present embodiment includes a separate software application to make virtual products interactive and be displayed 3 dimensionally in a 3D environment as the invention describes. The SP may be similar to 3D graphics programs (Cinema 4D, Bryce, 3D mak, True Space), which enables various objects to be imported and exported to other users of that program and can be integrated, interactive and displayed in a 3D format. In addition, like gaming programs such as Half-Life™ and others, the SP may have rendering, image processing, event processing, scene processing capabilities at the user level and also support virtual environments. Similar programs are commonly available or can be created using known techniques, such as those set forth, for example, in patent applications such as 2002/0156703 and the US patent 2002/024517 or other similar conventional virtual shopping applications.

As 3D objects are created, the objects may need to be converted or translated into a certain format to be compatible with the SP. Alternatively, objects may not need to enter the platform because the objects will be created within the platform or created for the platform. Thus when vendors create objects or virtual products, they may create and construct objects to be compatible with the platform, or non-compatible objects may be converted.

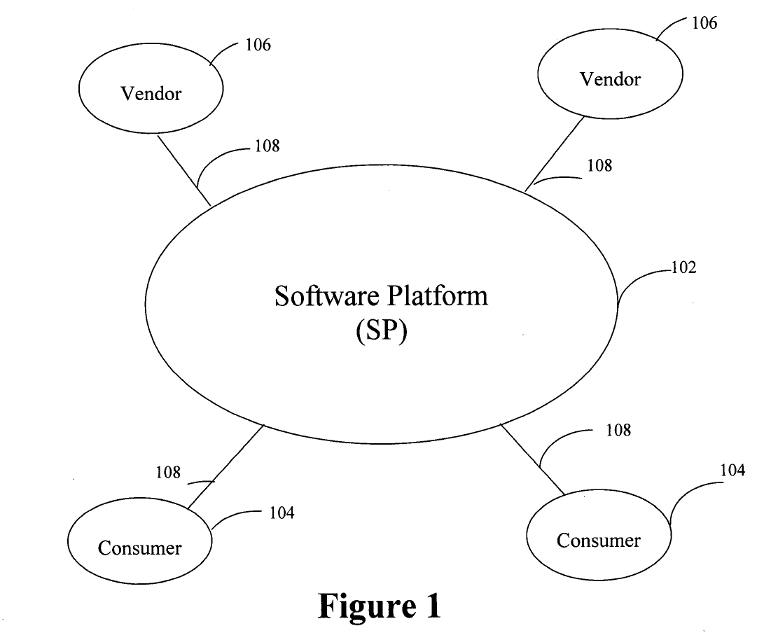

FIG. 1 illustrates by way of example the relationships of the consumer and the vendor, in accordance with one embodiment of the present invention. Software platform, SP 102, links all elements from consumers 104 and vendors 106 and can implement all the features of the SP. Link 108 applies to all the connections from consumer 104 and vendor 106 to SP 102, and may be any communication medium such as the internet, LAN, network, etc. In this embodiment, links 108 imply that consumers 104 and vendors 106 can communicate with each other within the SP 102. Consumer 104 can be linked to any of the vendors 106 within the platform, so it may be one vendor, multiple vendors, etc. that consumer 104 may communicate with. Likewise, vendors, 106 can communicate with one or multiple consumers 104 or with one or multiple other vendors 106. Additionally, vendor 106 is linked to other participating vendors 106 through SP 102 and consumer 104 is linked to other participating consumers 104 through SP 102. Therefore, any of the entities using the SP 102 will be able to use the functions and features of the invention.

As shown in the Figure, “object data” (such as data formulas for products), instructional data or any types of data may be transferred to any consumer 104 or vendor 106, in which the receiving party will locally process and display the data in their output device. As the data received from the plurality of vendors 106, are all within the prescribed format of the SP 102, consumers 104 can process data from multiple vendors 106 and use SP 102 to enable the functional features of SP 102. As the virtual products are transferred through links 108 and stored in the user's database, SP 102 may enable any virtual products from any vendor 106 to be interactive with each other. This will allow consumers 104 to simulate various scenarios and aspects of shopping within the consumer's computer or output device.

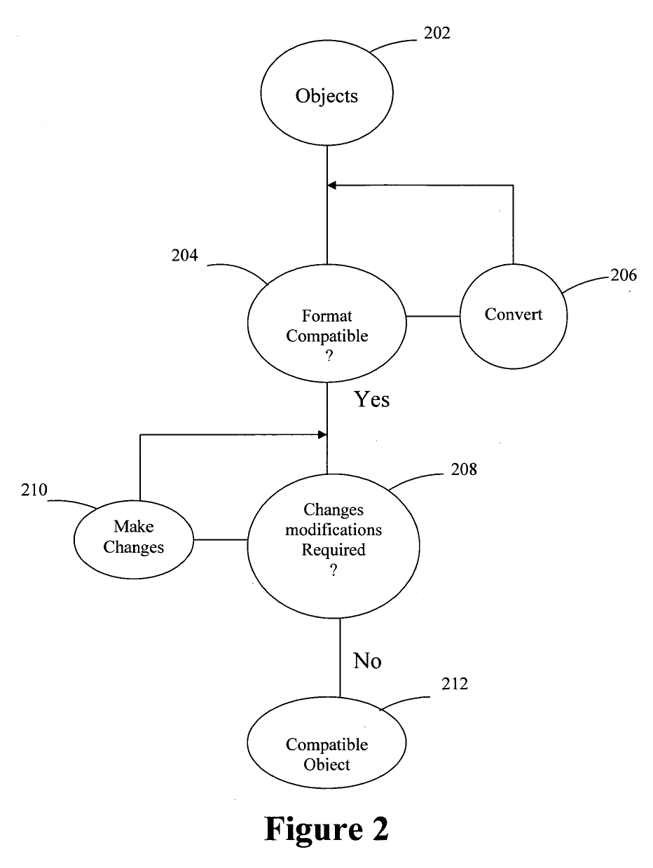

FIG. 2 illustrates an exemplary a method for properly handling potentially incompatible 3rd party objects that enter SP, in accordance with an embodiment of the present invention. Referring now to both FIGS. 1 and 2, as shown in FIG. 2 there may be other methods of converting, changing or manipulating objects from non-compatible to compatible status. The process begins at Step 202 where objects are entered into the SP for compatibility handling. The objects may be any objects that may be inserted into SP 102, which may include, but are not limited to, objects supported by SP 102, not supported by SP 102, personal 3D objects, 3rd party objects, scanned objects, any objects created in 3D graphics applications or any other objects that may need/want to be inserted into system platform 102.

SP 102 has the capability to convert 3rd party data into data (data or objects) compatible with SP 102. Compatibility does not simply imply a certain software format, but compatibility with SP 102. For example, the platform may support multiple software formats, and may convert data into any of the formats which are compatible. As a further example, if software formats A, B or C can be supported by SP 102, then the conversion capabilities will convert to any of the mentioned formats preferred by the user. Alternatively and preferably, SP 102 may support one centralized software format in which case it will convert to the centralized (standardized) format. Therefore, any 3D graphics applications not supported by SP 102 can be imported and converted to be compatible with SP 102.

After entering the object(s) into the system at Step 202, the compatibility handling process continues to Step 204, which step determines whether object 202 is compatible with system platform 102. If at Step 202 the object(s) is not compatible, the process continues to Step 206 in which SP 102 converts the object, using known format conversion techniques, to an SP compatible format and, thereafter, the process returns the converted object back to Step 202 to determine if the new format is compatible.

This process will be a loop until Step 204 allows object 202 to advance to step 208 which determines if changes or modifications are required. It should be appreciated that those skilled in the art will readily recognize how to implement a suitable format compatibility detection and conversion techniques in light of the teachings of the present invention. At Step 208, the procedure of assessing data will determine whether changes/modifications are necessary per SP programmed protocol. If, at Step 208, it is determined that changes or modifications to the data are required, data progresses to Step 210 where SP 102 makes any necessary changes. At Step 210 any modifications, editing, or adding of features, functions and/or capabilities is carried out. SP 102 allows changes to be made to the items being imported to make the objects functional in the SP. Alternatively any objects within the platform can be changed or modified. The changes may include wide assortment of changes or modifications that the system platform will support. When the procedure of making changes at Step 210 is complete, the process returns to step 208 where the SP programmed protocol once again assesses the data to confirm if any changes or modifications that were made were successful. This process loops until answered by “No”, in which case the data at Step 212 becomes a compatible object.

In some embodiments, to enable all the features, functionalities, and options available in the system platform, the user may need an SP browser. Some examples of browsers are plug in software, internet browsers, or other applications that will apply, process and/or or carry out all the functions associated with the system platform. The browser may have a user interface which is used to allow the user to carry out the various functions of SP 102, such as browsing through a virtual environment or websites, making the virtual products interact, or any other functions necessary to carry out the needs of the user. Alternatively, SP 102 may not need an SP interface, browser or any other software applications. The SP browser may be integrated with another browser, software program or embedded within an operating system etc. The SP browser may be responsible for storing information, processing the SP data, and displaying the final output on the user's terminal. The SP browser can store the SP data library for processing the data transmitted, or any other data which the SP needs to perform correctly. As data is transmitted to the various elements described (consumer 104 or vendor 106 in FIG. 1), the user receives the data, the browser processes the data accordingly, and the SP browser will enable the users to implement the various features of SP 102. Processing of the image can consist of, but not limited to image processing, rendering, event processing, data processing etc. to display the virtual products. Various components of this process can be used such as an applet, parser or other processing component necessary to process the data on the user level. A user interface will allow the user to be able to carry out the tasks. For example, the user interface may have various function buttons for the user to interactively carry out any desired tasks. User interfaces are commonly used on any computer application, and anyone in the art understands the role that the interface will play in the invention.

In another embodiment, SP browser may also allow for editing, manipulation or other changes in objects acting as a 3D graphics software application. In addition, SP browser may be used to convert or modify virtual products or other duties. The modified features can be including but not limited to, integration, measurement, placement, viewing options such as wire frame or color, and/or animation/movement. For example, if a consumer wants to import an automobile into the SP, the user can use the SP browser to add movements to the doors, hood, etc. The items for editing and other changes can include objects being imported or objects within the system platform or a combination of both.

In one embodiment of the invention, the user imports 3D images from his personal files in which the user converts, edits or manipulates the image from his SP browser and views and interact it with the other objects in the SP.

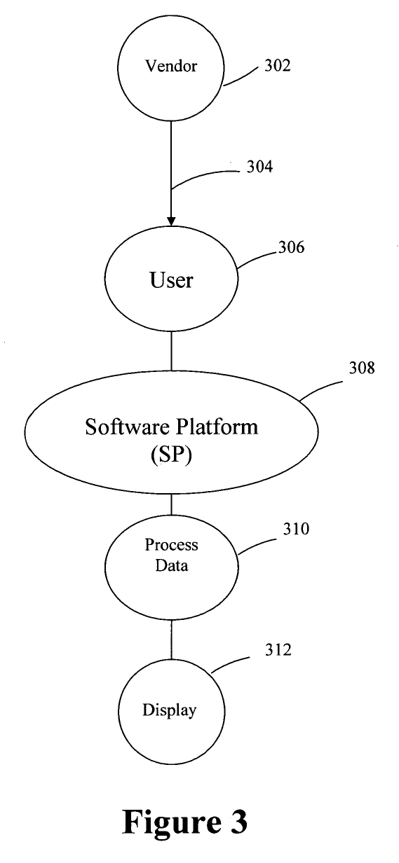

FIG. 3 illustrates an exemplary method of how obtained products from various sources can be carried out, in accordance with an embodiment of the present invention. The process begin at Step 302 where SP data (e.g., object formulas etc.) is sent from the vendor, sent via a communications link 304 to the user, at Step 306, where the SP data is received by the user. It should be appreciated that the vendor can be one vendor, multiple vendors or any other setting or source where the SP data will be coming from, and the communications link 304 may be any suitable communication medium, including but not limited to the internet, TV, networks, LAN, or any other means to which it will transfer the data to the Step 306, a user, and the user can be any user of the SP such as the consumer, vendor, or any other entity that will be using the SP. At Step 308, SP data is sent from the user to the SP where it will use the browser or other suitable methods to transfer the SP data to a data processing module for processing. At step 310, the data received by the data processing module is processed at the user level in accordance with a multiplicity of common and suitable processes, including but not limited to, rendering, data processing, scene processing, event processing etc. At Step 312, the processed data is received and displayed on the user's output device.

In addition, communication can be done through a portal or a server where a network can exist as a bridge between elements/terminals. Hence, vendor 302 may be a portal where it may bridge the transmission of data between the user and the vendor. Alternatively, the data may be stored in a server database, where data will be transferred, and be processed and displayed on the user's computer or terminal.

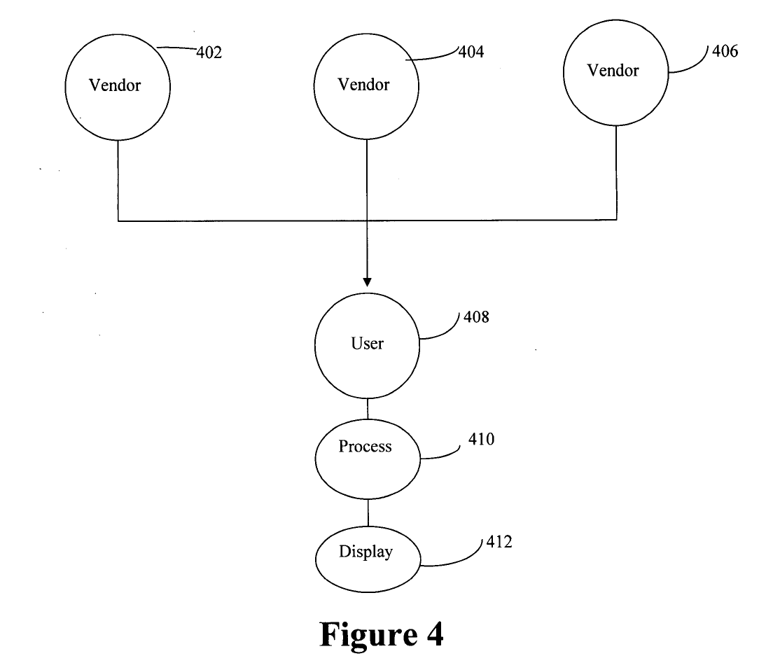

FIG. 4 illustrates an exemplary block diagram showing the flexible architecture of the SP, in accordance with an embodiment of the present invention. Given that the data received form one vendor does not substantially differ from another, the user can receive data from one vendor, multiple vendors or multiple entities. Vendors 402 404, and 406 represents a multiplicity of different vendors which may transmit data to user 408. User 408 can, for example, receive data from vendor 402 exclusively or receive data from some or all of the vendors 402, 404 and 406. In the present embodiment, when user 408 receives the data, the SP will enable it to be processed 410 and be displayed 412 at the user level. Conversely, the data can also be transmitted to the vendors from user 408. It should be appreciated that the present example is for illustrative purposes only and is not intended to limit the number, connectivity, or nature of the vendors, which vendors can be any element or entity.

One aspect of the invention is to allow vendors and consumers to share a common software platform, SP, for interactive virtual product display at the user level. In this embodiment, interactive is defined as a means allowing multiple virtual products from multiple vendors (or consumers) the ability to be interactively simulated as they do in the real world, preferably in a 3 dimensional environment. Objects can be integrated together, placed in different settings, moving parts simulated and other various features that the SP allows. Although this method can be used with a centralized server or system, a centralized system is not required to implement the functions of the present invention. This method allows for data to be transferred from one or more elements, where the data processing and implementing the functions of the SP are done at the user or client level.

In one preferred embodiment of the invention, one platform will be used in which all the objects and data from different entities will be compatible, interchangeable and interact with each other. The SP is a software platform which allows objects of the platform to be interactive as the SP allows. The platform can be one platform, series of platforms or a network of platforms, and they may or may not be all compatible with each other. However, each platform described above will have the capabilities of the system platform described in the invention. For example, platform A and B have the capabilities of the system platform, but may not be able to interchange objects with each other's platform or enact the functionalities of the SP with each other's objects The platform may provide a software format that enables objects from multiple entities to share a common standard. Through the SP, all the functionalities described in the invention can take place. A 3 dimensional object created by certain software may not be able to be viewed or edited with another 3D program. In addition, a photo taken by an individual may be viewed with a photo viewer, but one is not able to edit or manipulate the photo without a software program that supports a platform to edit and make changes to the photo. Similarly, the system platform described in the invention entails a platform that allows all the functionalities described in the invention and sets a standard for all the parties involved to use and operate on a common system platform. Such a platform unifies the data formulas to be interactive and to be displayed. Any objects and formats outside of the system platform may not be compatible and may not function and interact as the invention prescribes.

Depending on the needs of the particular application, the platform may be supported by one central graphics format or multiple formats which will enable the objects to interact with each other. Therefore the platform may allow for objects of multiple formats to be able to function and interact with objects as described in the invention. For example, platform may permit objects made from one software format or different software formats to operate all the functions described in the invention.

If objects are not supported by the platform, the objects may be converted to support the system platform. Hence, when system platform is mentioned in the present description, it implied that the objects have met the compatibility and format criteria to enable the functionalities described in the invention. In one aspect of the present invention, the SP is an environment in which all the functional capabilities of the invention are able to take place. The SP can be used with any vendor interface such as websites, TV programs, virtual reality store, or any other methods that vendors might use to display their products. The output device may be any terminal device known in the art.

Objects in the platform are able to integrate and/or merge and/or blend with other objects. The term integration generally refers to the compatibility and interactivity of objects and their ability to be combined together. The term integration can also mean, including but not limited to merging, blending, layering, fusing, joining, or combining the objects together. Integration is important because it allows items to establish contact, interact and to commingle with each other which further enhance the level of interactivity between objects. Thus, integration allows complementary items such as component parts or accessories to be integrated or combined, to an end item at hand. For example, if a camera is the end item, the all the custom lenses, parts or accessories can be added and integrated with the camera which enable the user to customize the camera. As further example, products which are made to fit with each other or items which are designed to be assembled together as components or parts or any other items which may require combining/integrating items together to obtain an end result may use integration to accomplish the task.

Inversely, the integrated item may be differentiated to view all the components separately. The exemplary camera may be differentiated to show all the different components either individually or isolated from one another much like an exploded view.

One aspect of integration may be accomplished by contact, referring to objects making contact with each other to join or fuse together. As an example, the exterior surfaces or the boundaries of the items may be fused, joined or mated together which will accomplish the integrated feature. Integration may be used with items which are made to fit together which may have boundaries that are complementary to one another. For example, custom taillights for an automobile may be integrated with the automobile that it was designed for. In addition, integration may include any contact between two objects to enable the interactively of integration. As a further example, a pair of sunglasses on a human head can also be contact integration.

Another aspect of integration may also occur when objects are layered or overlap with respect to each other. An object may be layered if an object is partially or entirely covered, enveloped, engulfed or layered on top or bottom of another item. For example, a human avatar may be layered in apparel, shoes, helmet, etc. or any other items that partially or entirely cover or overlap the avatar. Layered integration can be used to change colors of objects, or any other applications that require integration through layering.

Any of the meanings of integration mentioned above including but not limited to merging, blending, layering, fusing, joining, contact integration, layer integration or combining objects together, can be used together, simultaneously, synchronically, or in any arrangement or order with each other or with any other integration methods known in the art.

In another embodiment of the invention, various objects from a single vendor are able to be integrated together to be customized according to the consumer's preference.

In yet another embodiment, a consumer can bring together multiple complimentary objects from multiple vendors within the platform. Using the integration feature, the consumer can then customize the objects by integrating all the objects together as desired.

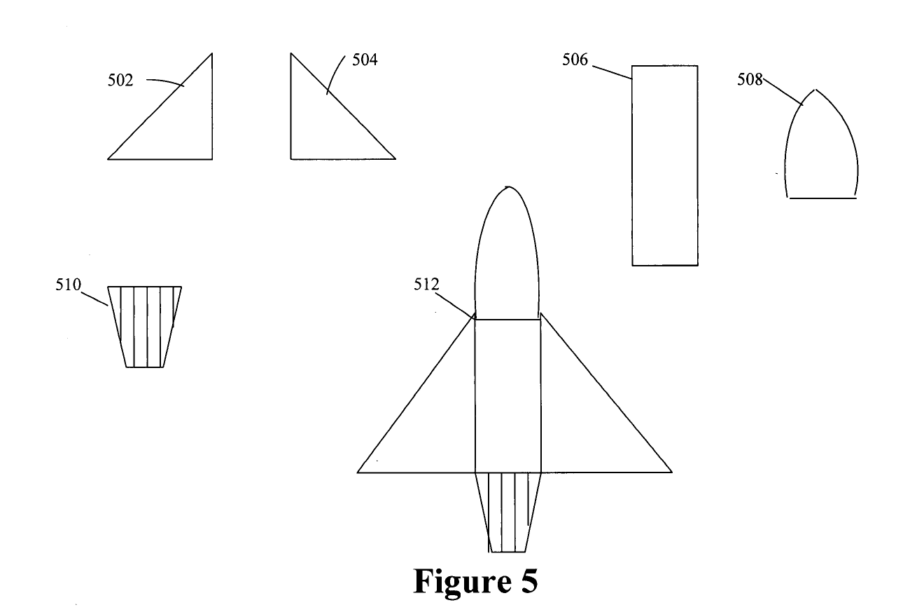

FIG. 5 illustrates and example of the integration feature, in accordance with an embodiment of the present invention. In the Figure, objects represented by left wing 502, right wing 504, airplane body 506, airplane head 508 and airplane exhaust 510 are objects obtained from various vendors. By the integration feature, airplane 512 is formed. 512 can be exemplified by hypothetically assuming that the wings 502, 504, the body 506 the head 508, the exhaust 510 are all brought together to customize the item and to view it as a single entity 512. By using integration, a fully customized airplane is displayed

In an aspect of the present invention, objects within the SP are provided with the ability to be proportional in measurement with respect to its actual measurements. Measurements can include length, height, width, weight and volume or any other measurement to get an accurate representation of the object. The measurement may be precise or general to a reasonable degree. This feature allows for users of the platform to obtain an accurate object representation in accordance with its dimensions. When the objects are created for the platform they may be created or captured to its size and dimensions. Alternatively, measurements can be inputted into the system for objects which have no measurement information. The SP may then adjust the proportionality and measurements consistent with the platform. For example, if an object is being imported from a third party without measurement specifications, the system may ask for its dimensions to implement and display it proportionally to the platform. Alternatively, user may freely choose to input preferred measurements according to their preference. Distance and measurement may also be proportional to each other. Therefore depth perception relative to its size and distance can be implemented. For example, an object two feet away with certain dimensions may be displayed in accordance to the depth perception consistent with viewing in reality. In addition, measurements of weight and volume can be implemented into the system. Thus as a 3 dimensional platform, volume may be an ideal representation of the object.

Measurement features may allow for proper fit for integration. In one embodiment of the invention, the system may integrate only objects that are able to fit with respect to each other. Alternatively, the system may integrate objects that do not fit and inform the user of the disproportionate measurements. Alternatively, objects with no measurements and objects with measurements can be integrated together.

In another embodiment of the invention, the system will output or recommend objects of a certain measurement according to the user's preference.

In one embodiment of the invention, integration will fit according to its volume measurements. This will allow user of the platform to get a 3 dimensional fit of the objects being integrated. For example, a user may need to purchase a container to store some items the user purchased at another store. Using the integration feature with the measurement feature, the user may find the “best fit” container by integrating the items into the container. Although the container may not be perfect, the user may get the best model to suit his or her needs. The display of the integration may inform the user of the fit according to its volume. Additionally, if there are no containers which satisfy the user, he or she may acquire another container (object) from another vendor to get the best possible product.

One aspect of Physical Properties is that the interaction may be as real as possible. The laws of nature may apply to the SP's environment to allow for more interactive features.

Hence, in some embodiments of the present invention, using, known techniques, objects are provided with physical properties and interactions that simulate real-world physics. This feature will allow realistic interaction with objects and display properties according to its measurements or physical attributes relating to the real world. Therefore, physical boundaries of the objects will be respected as well as other properties, limitations, or capabilities of the physical real world. Therefore if an object has certain volume or weight measurements, it may interact with another in accordance with its physical characteristics, its boundaries or its limitations. For example, a human avatar may be used as a simulation model in order to try on various clothes. If the clothing article is too big for the avatar, it may sag or simulate any other physical characteristics which may be associated with big clothing. Alternatively, the platform may create its own laws, rules or regulations on the physics, physical, chemical properties or any properties relating to the interaction of objects.

Other embodiments of the present invention further enable objects within the platform to be placed in any setting which is supported by or supports the platform. This is known as the placement feature of the invention and setting generally refers to any location within the SP. Some examples of settings are user's computer's interface/browser, vendor websites, TV sites, virtual stores, virtual worlds or any other interface which may display objects of the platform. As the data is transmitted from one user to the next, the user of the platform may freely move and place objects to and from or in and out of any settings. In addition, users may collect or consolidate objects from various settings or locations and place such objects into one setting. This implies that objects are not restricted to a specific location or setting and may behave as an entity which is compatible with any setting and are compatible and interactive with other objects. This is similar to a saved computer file which can be transmitted and modified by any other computer which is able to run the software program in which it was created. Therefore all the functionalities and features may be relevant to any location or setting regardless of where the object originated. The advantage of the placement feature is that consumers may co-locate objects from various vendors in the same setting without the hassle of navigating through different sites of different vendors and view them separately. In addition, placement or location of the objects within the same setting can be configured. For example, if a certain display pane has objects placed in a certain manner, a consumer can rearrange and configure the places and locations of the objects according to his or her preference.

In one embodiment of the invention, a consumer navigates through various vendors that support the platform and collects items from each vendor. The consumer then compares and is able to view all items in one viewing pane, comparing the various items, and implementing interactive functionalities such as integration with the objects that the consumer has collected.

In another embodiment of the invention, the user is given an arrangement of objects in a viewing pane. The user can use the placement feature to reconfigure or rearrange the object to his or her preferences.

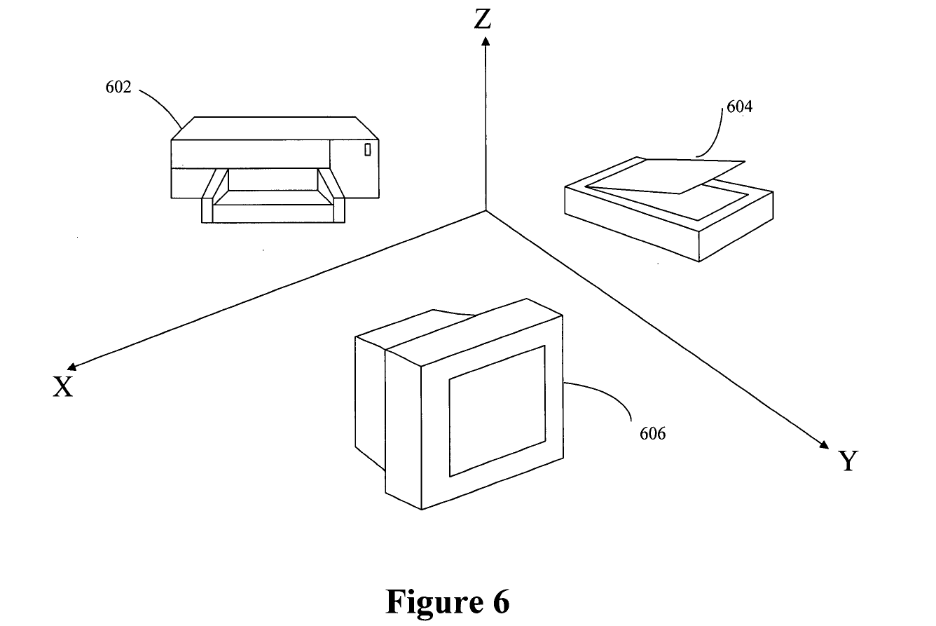

FIG. 6 illustrates an example of the placement feature, in accordance with an embodiment of the present invention. By having the X,Y,Z coordinates, this figure is in a 3-D interface environment. Items 602, 604, 606 are objects which may have been collected from various vendors or any data that the user may be processing. The 3D pane allows the items to be reconfigured at different locations within the 3D environment. These items can be reconfigured and displayed any way the user prefers. For example, 602 may be in 604's location or any other three dimensional location of that environment. The items may be viewed individually, integrated together, or arranged in any way which may suit the user's needs. As described above it may simulate in accordance with measurement to see what could go where. This may be used by furniture vendors who may want to enable their customers to simulate their family room and its measurement in which the furniture is moved or located as the user may prefer.

In some embodiments of the present invention objects within the system platform may be viewed and manipulated to view objects as we do in the real world. This feature is known as the viewing feature and these methods can include but are not limited to rotating, zooming, enlarging, spinning, flipping or any other viewing methods known in the art.

In one viewing feature embodiment, the platform may have viewing capabilities of viewing including but not limited to two dimensional, two dimensional with three dimensional attributes, or three dimensional. The viewing pane may be controlled by the user using a method called First Person View (FPV) or any other viewing methods known in the art. The FPV allows the user to control the viewing pane to move and browse the viewing pane to the preference of the user's perspective. For example, like many first person shooter games in the gaming market, the user can change his or her viewing pane based upon where the user moves or decides to look into the gaming environment. By the same token, FPV allows the movement of the viewing pane according to how the user prefers to view the object, by zooming or moving the viewing pane with respect to the objects. In addition, viewing may comprise of browsing in a virtual environment, or viewing virtual products in three dimensional spaces. As in FIG. 6, all the objects within the 3D environment can be viewed from all perspectives of that 3D environment.

Various aspects and methods of viewing may be used by using the mouse, keyboard, Virtual Reality devices, or any other instrument, input device or technique known in the art to properly implement the viewing feature. Alternatively, objects may be viewed by manipulating the objects with respect to the static viewing pane. This method (used in 3D graphics software) allows users to move and manipulate the object in order to view the object. And as mentioned above with the placement feature, the multiple objects from multiple vendors may be viewed in one pane or multiple panes and the viewing function can enable the objects to rotate, zoom and other viewing features necessary to get a closer inspection of the object. In addition, the viewing pane may be 2 dimensional or 3 dimensional in accordance with the most efficient or preferred method of viewing. The user has the freedom to view the object in any assortment of scenarios preferred by the user. For example, objects may be broken into various parts or various panes in order to view the various components of the objects or put together again by integration in order to view the objects as a single entity.

In a further embodiment of the invention, a user may integrate objects to view the objects as a whole, and differentiate the objects to get a closer look at the various components of the objects.

Further, another aspect allows users to view the insides of objects. In one embodiment of the invention, after a user has seen the exterior of an automobile, one can then choose to view the inside of a car by using FPV to zoom in closer or using other methods known in the art.

Another invention aspect allows objects within the system platform the ability to add movement or motion. This is known as animation in the invention and it allows for further interactivity of objects by allowing objects to add motion. Animation can refer to including but not limited to motion of various parts of components of objects, or motion with respect to other objects and/or any other motion, movement or animation. The objects may be created/scanned/imported or inserted with the animation/movement features added or objects from other applications or platforms can be imported, modified, converted or redesigned to add the animation/movement features. For objects with moving parts, or products that have motional functions, this feature will allow for the objects to implement them in the system platform and it may be incorporated by using the proper animation/movement or rendering techniques known in the art. For example, a user decides to see a new automobile that just came out on the market. The animation/movement feature will enable the car to open the doors, hood, trunk, etc. In addition, any object in the platform may have motion, thus two objects can interact with each other by moving with respect to each other or any objects in a virtual space may move or have motion like in the real world.

In one embodiment of the invention, motion of objects can also be incorporated through a timed relationship and thus create a timed animation movement of objects. Therefore, the platform has the capability to add sequence of motion or events to create animation with respect to time. In one embodiment of the invention, a user can view how fast an object moves by synchronizing the motion with respect to time. This technology is similar to gaming engines, where animation is the constant rendering of different frames according to the events of the game. In the gaming environment, objects can move, be animated or give the effect of moving to the user. Therefore, various technologies can be implemented to give the illusion of animation or have actual animation.

In one embodiment, the animation feature can be implemented simultaneously with the viewing feature or any other features of the system platform. For example, after viewing the exterior of a car, user can open the doors to inspect a closer look at the interior of the car.

In another embodiment, user can add animation features to an object which may not have previously had animation built in. For example, if a human avatar is used in the SP, the user can add different animation/movement features to make the avatar sit, walk, run, or have the avatar pose in any position.

The system platform can support three dimensional virtual environments. 3 dimensional virtual environments or virtual space will enable the system platform to create and/or implement 3 dimensional space within the system platform. As any space in the real world, virtual space may represent space which can be used for any application. Therefore, virtual space can be used for gaming environments, shopping environments, virtual reality environments, personal virtual space or any other 3D virtual applications known in the art. Consumer may view objects in virtual 3D environments and the SP user interface viewing may be 3D. As an example, as in FIG. 6, the virtual product arrangement is in virtual space with the X, Y, and Z coordinates. The virtual space may be comprised of any objects within the SP and may be created using various objects in the platform and can consist of objects which were created with the virtual space. For example, if a vendor creates a virtual space representing a 3 dimensional depiction of an actual store, the virtual store may consist of the objects which were created by the virtual store, or with objects which were imported from another vendor whose products are compatible with the SP.

The 3D virtual space is just an extension of the SP, and simply describes the platform in a full 3 dimensional layout. Thus objects may be inserted, plugged in and out, imported or exported between any entity that supports/supported by the platform and any objects in the 3D virtual space. In addition, any object within the SP may be able to implement the function of the SP in 3D virtual space. For example if a vendor displays his products in a 2D website, the consumer may obtain the virtual product and insert the virtual product into a virtual space. Same events can happen inversely, and may progress from the virtual space to the vendor's website.

Alternatively, other supporters of the SP (websites, TV sites, portals, etc.) may be of the same SP (it is able to do all the functions of SP), but not compatible with each other. For example, SP A which supports all the functions of the software platform may not be compatible with SP B which can also implement all the functions of the system platform. Therefore, products or items in SP A may not be able to interchange products with SP B. However all the products of SP A can implement all the functions of SP within the SP A's format.

In one embodiment of the invention, a user can customize a 3D virtual space by inserting objects into the virtual space. For example, if a consumer has gathered various virtual products form various vendors, he can create a virtual space where the virtual products will be displayed 3 dimensionally. The consumer can then arrange the virtual products in a certain way to get a better depiction of how the virtual products may look according to its arrangement. This has been exemplified in FIG. 6, where this takes place in 3D virtual space environment. This method of placement can be done with the measurement to get an accurate idea of the possible arrangement according to an object's measurements and how they may look.

Depending on the needs of the particular application, other features that make objects in the SP more interactive or like the real world can be used. Sounds and shadows for example can be used if necessary. Any other features which will help the SP get a better depiction of reality can be included in the invention.

It should be noted that the different properties and features described for the SP are extensible and/or optional. As those skilled in the art will readily appreciate, all or any combination or subset of the features and functions of the present invention may be implemented as dictated by the needs of the particular application

However, herein it will be assumed that all the features and functionalities are being implemented. In one embodiment, humans can be scanned, imported, or inserted into the system platform and any other insertion methods known in the art can be used. There are many methods known in the art for 3D image capturing as well as 3D image capturing for humans. The 3D clone/image (known as an avatar) of the human may be in SP data and can be stored in the user's database or within any other database or databases. The avatar may be used by the user as a representation of himself/herself in the system platform. The avatar may be able to be animated (move like a human being), integrated, merged, blended, or any other functions or features implied in the system platform with other objects in the system platform. The avatar may also be in proportional measurement with respect to other objects and may be placed with other objects or anywhere in a 3D virtual space or any other platform setting.

In one embodiment of the invention, the avatar may be stored in the user's database or be used as a model to try on various clothing from different vendors. The virtual products of vendors which are proportional in measurement and compatible with the avatar may enable the avatar to be seen with all different articles of clothing using the layered integration feature.

In another embodiment of the invention, different virtual products may be compared in size relative to the avatar. For example, a user may compare the size of a bed compared to the size of the avatar.

In another embodiment, the different parts of the avatar may be compared to be viewed with other objects. For example, a camera might be compared to the size of the avatar's hand or a set of sunglasses may be placed on the avatar's head to get an accurate picture of how the glasses might look on the user.

In a further embodiment, the avatar may be animated for movement or be configured according to the user's preference. For example, the avatar may be animated to be configured to be in a sitting position, and the avatar may be fit into an automobile to see how it will fit and how it may look in the driver's seat in the automobile. The avatars will also be able to be used as a representation of the user in the 3D virtual space.

In one embodiment of the invention, the user will use the avatar to browse through the 3D virtual world to shop, interact with other avatar representations, and use the avatar for gaming purposes or dating purposes.

In a further embodiment of the invention, a user can import various avatars from different applications, or create avatars within the system infrastructure.

As described in the invention, any vendor may be independent of any centralized system. Therefore, in one embodiment of the invention, the vendor may implement the SP on a stand alone or an independent site. This site refers to any web page, TV site, or any other vendor interface for shopping and can be linked to other interfaces for display. The consumer can be linked to this vendor through any communication means, and through the SP implement the features of the SP with the vendor's virtual products. As an example, an electronics vendor has all the 3D objects in their website that support the SP. The vendor's website can offer the functionalities of the platform so the consumer can, through the interface, customize and utilize the viewing feature, integration feature, placement features and other features to get a better analysis of the products they wish to buy. In a further example, a custom auto parts dealer may offer a car as a model as an end item and allow the user to integrate custom parts with the car for a consolidated view of the custom parts.

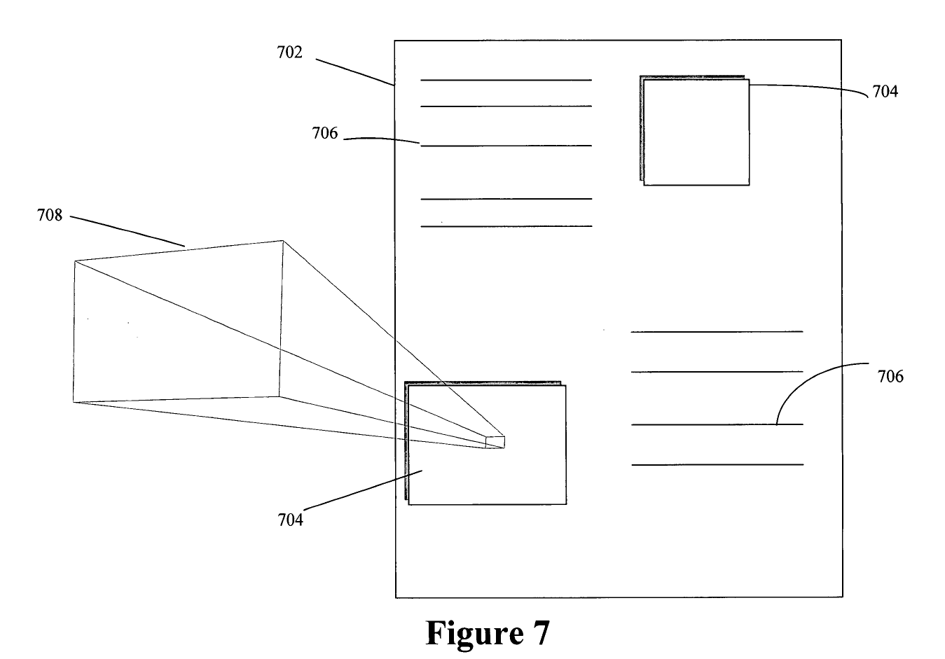

FIG. 7 illustrates an example of how a webpage may look like. Webpage 702 may represent any vendor interface/site. The lines 706 represent the texts within the website and the box 704 represents the window of interface or display of the SP. Although this may be a HTML webpage or other vendor site, the SP interface/browser may be embedded within the main browser (in this case HMTL browser). As 704 will display items which process the functionalities of the SP, it may have animated virtual products in which the user can use the integration, placement, viewing and other manipulations of the SP. These “windows” may be for advertisement or a 3-D representation of a product within the website. As the user “clicks” on the window, the window may expand for better viewing or the user may view and manipulate item within the given window. Expanded window 708 represents the expanded window of 704 and the direction or the location is just an illustration of the expansion. Therefore, the expanded window may be the full screen, half screen or any other size or perspective the user may prefer. In some applications, this may be ideal if a user is interested in a closer 3-D inspection of an advertised product within a 2-D webpage. Furthermore, the user may “export” the item and enable all the functions of the SP with other virtual products the user has collected. In this case, the item descriptions may be 706 and the 3-D virtual product may be displayed in 704. After the user has decided to collect the virtual product, the user may enter another 3-D environment to integrate it with another item. The example is for illustrative purposes only and is not restricted to the descriptions above.

Alternatively, user can use objects from imported items from other vendors to utilize the functions of the platform with the said vendor's products.

In another embodiment of the invention, the vendors may construct a 3D virtual store using 3D virtual space. The 3D virtual store may be used as a representation of an actual store by the vendor. The 3D virtual store in turn, may be plugged into a virtual world, linked to a website or be used as any other functions that the vendor may require. For example, if a vendor wanted to create a representation of an actual real world store, the 3D virtual space will have all the products he offers in a 3 dimensional layout like in an actual store. Users can browse the virtual store using the user interface and using various methods for navigating through a 3D virtual space. In this scenario, the users may use 3D virtual helmets, gloves or any other tools available for the user.

Furthermore, this will give the vendors more creative freedom and the capacity to implement their own efficient layout plans, designs or any other techniques and methods they require to have in a virtual store. The vendor virtual products and the items may all be constructed to meet the requirements and the specifications to be supported by and/or support the SP. This may imply that the objects in the 3D virtual space and 2D webpage are interchangeable amongst each other and are capable of all the functions and features of the SP. It may further imply that the objects in the 3D world and the objects in the 2D web page are essentially the same, just in different settings. As explained throughout the invention, the objects within the SP are able to perform all the tasks explained in the invention. As an example, the user may compare and integrate an object from a web page (or any vendor interface) with an object from a 3D virtual store. Due to the flexibility of the browser, the line between a web page and a 3D virtual space may be blurred. As seen in the interfaces in the 3D graphics applications, they can serve both at the same time.

Alternatively, the website and the 3D virtual store may not be compatible with each other. For example, a website and virtual store may both support the system platform, but the objects may not be interchangeable with each other. When the user enters the 3D virtual store, the system browser can allow for the user to navigate through a first person view, similar to the First Person Shooter gaming formats or any other browsing technique known in the art to allow for an efficient usage.

In another embodiment of the invention, with the website and the virtual store in place, vendors may have a hybrid of a web page that a 3D virtual represents as a three dimensional store. The vendor may have just a website, just a virtual store or both representations as a hybrid. This allows for users to browse through the site in a 2D webpage or a 3D virtual store atmosphere. These two attributes of the vendor's site may be linked together in such that the user can enter in and out of each other from either representation. For example, the user may enter the 3D virtual store through the website, or enter the website through the virtual store.

In another embodiment of the invention, a network can be created to connect all the various elements of the platform. The elements can include but are not limited to the vendors, consumers, users, system server or any other entity or elements which uses, supports or utilizes the platform. It can be one network, multitude or a series of networks combined to work together. The network provides an efficient way to access all the different vendors and elements which support the platform, and may also create a community of all the various elements of the platform. In addition, various elements of the network can share resources and ensure security and proper functionality of the platform. Without browsing through a large communications infrastructure to find vendors which support the platform, this network may reduce the hassle and provide user with an efficient channel of locating and accessing the elements of the platform. The network may comprise of a small network of vendors connected together. As an analogy, a workgroup in a computer network is a small network comprised of limited amount of users and does not require a main server or other formalities of a major network. Similarly, the small network of vendors may comprise of a small number of vendors without any sophisticated system or a server to maintain the network. Simply put, it is small number of vendors connected together. When the networks are connected together, it also implies that a user can “hop” from one vendor to the next. This will allow the consumer to gather data efficiently and implement the features of the SP with the data (object, formulas, etc.) collected. Similarly, in games engines, this is done where different players create their own networks and environments to play their game.

In another embodiment, a network may comprise of only 3D virtual stores. The user then hops from one 3D virtual store to the other creating the effect of a virtual world. The user may use an avatar to represent him/her self in the stores, or use the system interface to browse the virtual stores in First Person View or any other browsing methods known in the art. For example, user enters the network and enters a virtual store with an avatar representing the user. From the initial virtual store, the user can then hop from one virtual store to the next, through the links provided by the network. This may have the effect of a virtual shopping environment.

In another embodiment, the network can also comprise of a sophisticated network or multitude of networks combined together. It may be comprised of including but not limited to administrator, system server, system database, vendors, consumers, or any other element/entity which might play a vital role in the use of the network, or maintaining and/or operating the network. With a centralized organization, the network can provide vital services and functions and will entail a more sophisticated system and infrastructure. For example, technical problems, consumer complaints, can be addressed by the administration and any rules, laws or regulations can be enforced throughout the network to provide an efficient and a quality system architecture. Consumers can also enjoy the benefits of a community of vendors that support the SP as well as a competitive marketplace. In addition consumers may also search for products within the system architecture. Again the SP will allow for data to be processed at the user level.

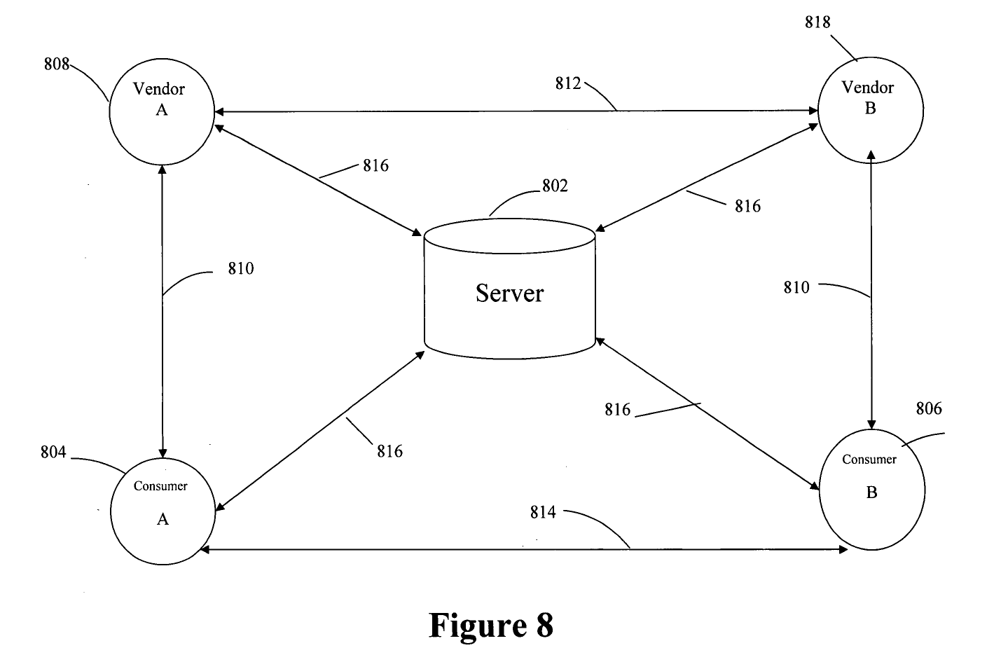

FIG. 8 illustrates an exemplary centralized a virtual environment server architecture, in accordance with an embodiment of the present invention. In the Figure, server 802 is the centralized location where it may host a virtual environment, act as a portal or as a gateway. Server 802 may be a website, or a server (which may have web server and a database). Consumer A, represented as 804 and consumer B, represented by 806 and vendors are represented by 808 and 818. Vendors, 808, 818 represented in this figure represent all the different display methods of the vendor (website, virtual store, etc.). Link 810 represents the link from vendors 808, 818 directly to any consumer 804, 806. Link 812 represents any link from vendor to vendor, and link 814 represents link from consumer to consumer. Link 816 is a link which connects everyone to and from server 802. As described above, the server may host virtual environments, link vendors with consumers, or act as a gateway. This figure shows that all the elements can be connected through the server, thereby acting as a portal or gateway. The server will transmit the data to the elements in which case the users will process and display their data within their computer/terminal.

In a further embodiment, centralized server can act as a portal or a gateway for the various elements that support the SP. Common portals we see today are Google™, Yahoo™, eBay™, Netscape™ and other various portals that we have on the net. It can be in a central location where consumer may download software, get updates, search for various vendors or products, get technical help with SP, etc. The vendors may store their product data, vendor information, or have a link directing consumers to their website. If the product data is located in the server, product data can be transmitted using link 816. If however the server directs the consumer to the vendor, link 810 can be used. Links 816 and 810 can be used in any way to better suit the needs of the users. Also, consumers may store their personal information, store product data or any other functions in the server database which may help the consumer obtain an efficient shopping experience. In turn, stored data may be transferred through link 816 where it will be processed, stored and/or displayed at the consumer/user level.

In another embodiment, the server may use the virtual stores of the vendors to create and host a centralized virtual shopping environment. Similar to how a gaming engine works, it may host a virtual shopping center where the virtual stores can be plugged into the virtual shopping environment. Due to the fact that all the various elements are all within the SP, virtual stores, virtual products and virtual shopping environments may all be easily integrated into one system. In addition, all the objects within this system may be able to be interactive with each other as described in the platform. Like any First Person Shooter gaming platform, the user can browse the virtual environment and interact with various elements of the environment. In games like Counter Strike™, Half Life™ and other games in the market, various “environments” and networks can exist. Various environments or networks may be similar to internet chat rooms or communities who may shop together, commingle with each other and share their thoughts and experiences. Additionally, the central server will transmit the necessary data to the user where processing and display will be at the user level. In this case the server may act as a control center where it will make sure that data will be transmitted correctly.

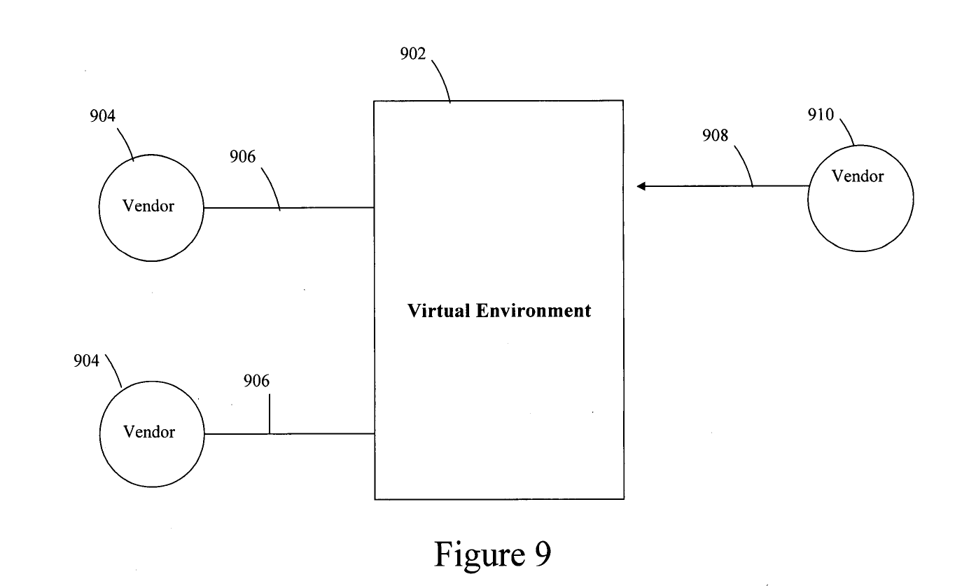

FIG. 9 illustrates an exemplary top-level architecture of how users and vendors connect to a virtual store, in accordance with an embodiment of the present invention. In the Figure, a virtual environment 902 such as a shopping environment is created. Vendors 904 may be plugged into the virtual environment 902 and a communications link 906 may be established. A vendor 910 represents a vendor who is not plugged into the virtual environment, but through a communications link 908, it can be plugged into the virtual environment due to the SP. When plugged in, vendors may be connected to multiple users and vendors in a centralized shopping virtual environment, where the compatible data may be interchanged and used interactively. For example, a user in virtual environment 902 is linked to vendor's 904 website via communications link 906. In an alternate embodiment, the user may enter the vendor site via a website outside of the virtual store, or via the virtual environment (e.g., a virtual store), and the communication links will provide the means for the user/consumer to use both vendor interfaces

As the SP is an interactive display application, it can be used to host any number of various virtual environments. Environments can include shopping environments, gaming environments, socializing environments, educational environments, etc.

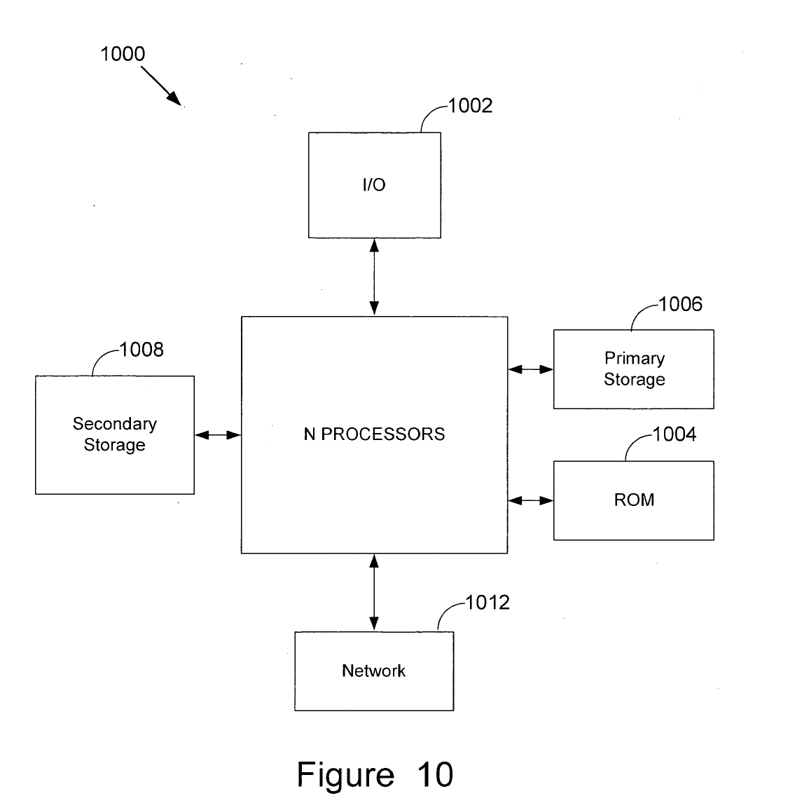

FIG. 10 illustrates a typical computer system that, when appropriately configured or designed, can serve as a computer system in which the invention may be embodied. The computer system 1000 includes any number of processors 1002 (also referred to as central processing units, or CPUs) that are coupled to storage devices including primary storage 1006 (typically a random access memory, or RAM), primary storage 1004 (typically a read only memory, or ROM). CPU 1002 may be of various types including microcontrollers and microprocessors such as programmable devices (e.g., CPLDs and FPGAs) and unprogrammable devices such as gate array ASICs or general purpose microprocessors. As is well known in the art, primary storage 1004 acts to transfer data and instructions uni-directionally to the CPU and primary storage 1006 is used typically to transfer data and instructions in a bi-directional manner. Both of these primary storage devices may include any suitable computer-readable media such as those described above. A mass storage device 1008 may also be coupled bi-directionally to CPU 1002 and provides additional data storage capacity and may include any of the computer-readable media described above. Mass storage device 1008 may be used to store programs, data and the like and is typically a secondary storage medium such as a hard disk. It will be appreciated that the information retained within the mass storage device 1008, may, in appropriate cases, be incorporated in standard fashion as part of primary storage 1006 as virtual memory. A specific mass storage device such as a CD-ROM 1014 may also pass data uni-directionally to the CPU.

CPU 1002 may also be coupled to an interface 1010 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1002 optionaily may be coupled to an external device such as a database or a computer or telecommunications or internet network using an external connection as shown generally at 1012. With such a connection, it is contemplated that the CPU might receive information from the network, or might output information to the network in the course of performing the method steps described in the teachings of the present invention.

Having fully described at least one embodiment of the present invention, other equivalent or alternative methods of interactive three-dimensional item display according to the present invention will be apparent to those skilled in the art. The invention has been described above by way of illustration, and the specific embodiments disclosed are not intended to limit the invention to the particular forms disclosed. The invention is thus to cover all modifications, equivalents, and alternatives falling within the spirit and scope of the following claims.

1. A system for interactive three-dimensional (3D) object simulation, the system comprising:
means for simulating an interactive 3D environment;
means for receiving an object, the object having a particular format;
means for checking if the object is in a compatible format;
means for converting the format of the object to a compatible format;
means for determining if modifications are required to the object to make the object functionally compatible with the said 3D environment simulating means;
means for modifying the object to make the object functionally compatible with said 3D environment simulating means, whereby said 3D environment simulating means is operable to receive and properly integrate the object into the simulated interactive 3D environment, thereby creating a simulated version of the object, or virtual object, in the simulated interactive 3D environment; and
means for displaying the interactive 3D environment.

2. The interactive 3D object simulation system of claim 1, further comprising means for manipulating the virtual object at least partially similar to the real world manipulation of a physical version of the object.

3. The interactive 3D object simulation system of claim 1, further comprising means for at least partially simulating real-world physics in the interactions between virtual objects and between the virtual object and the interactive 3D environment.

4. The interactive 3D object simulation system of claim 3′, further comprising means for enabling a consumer to integrate virtual objects obtained from a plurality of vendors.

5. The interactive 3D object simulation system of claim 4, wherein only virtual objects that are able to dimensionally fit with respect to each other may be integrated by the consumer.

6. The interactive 3D object simulation system of claim 1, further comprising means for enabling a vendor to place an object into the interactive 3D environment.

7. The interactive 3D object simulation system of claim 1, further comprising means for a vendor to create a 3D virtual store in the interactive 3D environment.

8. The interactive 3D object simulation system of claim 1, further comprising means for enabling a vendor's website to cooperate with the 3D object simulation system such that a consumer can functionally utilize the full functionality of the 3D object simulation system via the vendor's website.

9. The interactive 3D object simulation system of claim 1, further comprising means for a consumer to import a virtual object from a vendor into the interactive 3D environment.

10. The interactive 3D object simulation system of claim 1, further comprising means for animating motion of the virtual object in the interactive 3D environment.

11. The interactive 3D object simulation system of claim 1, further comprising means for exporting the virtual object from the interactive 3D environment.

12. The interactive 3D object simulation system of claim 1, wherein the virtual object is dimensionally proportional in measurement to the dimensional measurements of the corresponding physical object.

13. The interactive 3D object simulation system of claim 1, further comprising means for enabling a user to freely move and place virtual objects to and from any location in the interactive 3D environment.

14. A method for interactive three-dimensional (3D) object simulation, the method comprising the Steps of:
simulating an interactive 3D environment;
receiving an object, the object having a particular format;
checking if the object is in a compatible format;
if the object is not in a compatible format, converting the format of the object to a compatible format;
determining if modifications are required to the object to make the object functionally compatible with the said 3D environment simulating means;
modifying the object to make the object functionally compatible with said 3D environment simulating means, whereby said 3D environment simulating means is operable to receive and properly integrate the object into the simulated interactive 3D environment, thereby creating a simulated version of the object, or virtual object, in the simulated interactive 3D environment; and
displaying the interactive 3D environment.

15. The interactive 3D object simulation method of claim 14, further comprising the Step of at least partially simulating real-world physics in the interactions between virtual objects and between the virtual object and the interactive 3D environment.

16. The interactive 3D object simulation method of claim 15, further comprising the Step of a consumer to integrating virtual objects obtained from a plurality of vendors.

17. The interactive 3D object simulation method of claim 16, wherein only virtual objects that are able to dimensionally fit with respect to each other may be integrated by the consumer.

18. The interactive 3D object simulation method of claim 14, further comprising the Step of a vendor to place an object into the interactive 3D environment.

19. The interactive 3D ob ject simulation method of claim 14, further comprising the Step of a vendor to create a 3D virtual store in the interactive 3D environment.

20. The interactive 3D object simulation method of claim 14, further comprising the Step of a consumer importing a virtual object from a vendor into the interactive 3D environment.

21. The interactive 3D object simulation method of claim 14, further comprising the Step of manipulating the virtual object at least partially similar to the real world manipulation of a physical version of the object.

22. The interactive 3D object simulation method of claim 14, further comprising the Step of animating motion of the virtual object in the interactive 3D environment.

23. The interactive 3D object simulation method of claim 14, further comprising the Step of exporting the virtual object from the interactive 3D environment.

24. The interactive 3D object simulation method of claim 14, further comprising the Step of configuring the virtual object to be dimensionally proportional in measurement to the dimensional measurements of the corresponding physical object.

25. The interactive 3D object simulation method of claim 14, further comprising the Step of enabling a user to freely move and place virtual objects to and from any location in the interactive 3D environment.

26. A computer program product for interactive three-dimensional (3D) object simulation, the computer program product comprising:
computer code that simulates an interactive 3D environment;
computer code that receives an object, the object having a particular format;
computer code that checks if the object is in a compatible format;
computer code that converts the format of the object to a compatible format;
computer code that determines if modifications are required to the object to make the object functionally compatible with the said 3D environment simulating computer code;
computer code that modifies the object to make the object functionally compatible with said 3D environment simulating computer code, whereby said 3D environment simulating computer code is operable to receive and properly integrate the object into the simulated interactive 3D environment, thereby creating a simulated version of the object, or virtual object, in the simulated interactive 3D environment;
computer code that displays the interactive 3D environment; and
a computer-readable medium that stores the computer code.

27. The interactive 3D object simulation system of claim 26, further comprising computer code that enables a vendor to place an object into the interactive 3D environment.

28. The interactive 3D object simulation system of claim 26, further comprising computer code that creates a vendor 3D virtual store in the interactive 3D environment.

29. The interactive 3D object simulation system of claim 26, further comprising computer code that enables a vendor's website to cooperate with the 3D object simulation system such that a consumer can functionally utilize the full functionality of the 3D object simulation system via the vendor's website.

30. A computer program product according to claim 26 wherein the computer-readable medium is one selected from the group consisting of a data signal embodied in a carrier wave, a CD-ROM, a hard disk, a floppy disk, a tape drive, and semiconductor memory.
